(19) United States
(12) Patent Application Publication
(10) Pub. No.: US 2001/0022724 A1
(43) Pub. Date: Sep. 20, 2001

(54) Spirit light decoration

(76) Inventor: Thomas J. Mertz, Michigan, MI (US)

Correspondence Address: William J. Clemens, MacMillan, Sobanski, & Todd, LLC, One Maritime Plaza, Fourth Floor, 720 Water Street, Toledo, OH, 43604, US

(21) Appl. No.: 09/797,525

(22) Filed: Mar. 1, 2001

Related U.S. Application Data
(60) Provisional application No. 60/185,989, filed on Mar. 1, 2000.

(51) Int. Cl. F21V 21/00

(52) U.S. Cl. 362/249; 362/252; 362/812; 362/396

(57) ABSTRACT

A novel decorative apparatus is disclosed that depicts various symbols including sports, school, or holiday symbols by providing a frame in the shape of the desired symbol. The frame is provided with connection devices that orient small electric lamps in a predetermined direction whereby the small electric lamps outline the symbol.

### BACKGROUND OF THE INVENTION

The present invention relates generally to lighted decorations and, in particular, to a lighted decoration having an ornamental and/or symbolic body shape. Holiday decorations utilizing small electric lamps are well known. Hanging decorations utilizing plastic frames of various types are also well known. In addition, decorations that depict sports team logos, school mascots, school symbols and the like utilizing small electric lamps have proved to be quite popular.

There have been numerous embodiments of lighted decorations in the prior art. Many prior art embodiments utilized planar surfaces drilled with a plurality of holes in a variety of decorative shapes or patterns. The small electric lamps were then placed within the holes for ornamental effect. Other prior art embodiments utilized a plastic frame, rather than a planar surface, which contained a channel upon which connection devices were placed. The small electric lamps were attached to the connection devices in the channel such that the lamps were oriented perpendicular to the frame and the electric wires connected the lamps were routed through the channels.

The prior art embodiments did not show or contemplate positioning of the connection devices on the plastic frame such that they would be oriented towards a predetermined viewing location. Nor did the prior art embodiments show or contemplate a means for hanging, the grouping of the lights for use of two or more frames with one string of lights, or direct current operation. It is desirable to produce a novel lighted decorative apparatus that utilizes these characteristics not shown in the prior art.

An objective of the invention is to provide a novel lighted decorative apparatus that depicts symbols including sports, school, or holiday symbols by providing a frame in the shape of the desired symbol. The frame is provided with connection devices without utilizing a channel for routing electric wires that orient small electric lamps towards a viewer whereby the small electric lamps outline the symbol.

Another objective of the invention is to provide a novel decorative apparatus that further provides a means for hanging the symbol.

It is another objective of the invention to provide a novel decorative apparatus that may be connected to a variety of power sources.

It is yet another objective of the invention to provide a novel decorative apparatus that may be sold as a plurality of symbols.

It is still yet another objective of the invention to provide a novel decorative apparatus that may be embodied with or without the small electric lamps.

### SUMMARY OF THE INVENTION

The present invention consists of a preferably plastic frame approximately, but not limited to, six inches square in dimension with supporting clips that hold in place small lights such as those used for holiday decorations. The frame is preferably constructed in the decorative shape of a collegiate symbol or initial, the decorative shape designed to be viewed from a predetermined direction. Alternatively, the frame may be constructed in the shape of symbols for holidays such as a pumpkin for Halloween, or an Easter egg for Easter. The frame has an attachment with at least one built-in eyelet. Wire, string, or the like is then routed through the eyelet and used to suspend the frame in such a way that presents the image in the predetermined direction from which it is intended to be viewed.

The frame is preferably constructed of clear plastic material in either rounded or multi-faceted form so as to enhance the illumination effect of the lamps. Alternatively, the frame is constructed of an appropriate color, such as a school color. A plurality of clips in clip bodies is located on the frame in a design to produce the detail necessary to clearly identify the image or symbol intended. The clips allow the base of each lamp to “snap in” and be held in position on the frame. The clips orient the lights towards a viewer in a manner that outlines the symbol. The alignment of the clips orient the top of the lamp toward the viewer such that the clip and the clip body are substantially hidden, permitting closer spacing of the lamps and enhancing the illumination effect of the lamps. The frame size is determined by the detail requirements of the symbol.

A plurality of small electric lights may be provided with the present invention. The lights may be colored according to the symbol identity requirements, for example, orange for a pumpkin or a school color for a school trademark. The lights may be constructed in groups, for example groups of 40 lights, with minimal necessary spacing between lamps to minimize exposed wire. The groups of lights are connected by an electrical cord and the light groups are assembled with a gap of, for example, 36 to 48 inches between the groups to allow “random” spacing of a plurality of symbols if they were, for example, to be hung in a tree as Christmas ornaments. The electrical cord has on opposing ends either a plug or socket so the cords may be attached and hung in series. A plurality of symbols would accompany the electrical cord; the number of symbols corresponding to the number of light groups.

In a preferred embodiment, the invention includes only the decorative shaped frame with associated clips and clip bodies. In this preferred embodiment, the lights are provided and installed separately by a consumer. In another preferred embodiment, the invention includes at least one and preferably a plurality of decorative shaped frames and appropriately colored lights or a set of lights. The invention, therefore, may be practiced with or without the plurality of lights and accompanying electric cord.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front elevation view of the spirit decoration in accordance with the present invention;

FIG. 2 is cross-sectional view taken along the line 2-2 in FIG. 1; and

FIG. 3 is a wiring schematic for the spirit decoration shown in FIG. 1.

### DESCRIPTION OF THE PREFERRED EMBODIMENTS

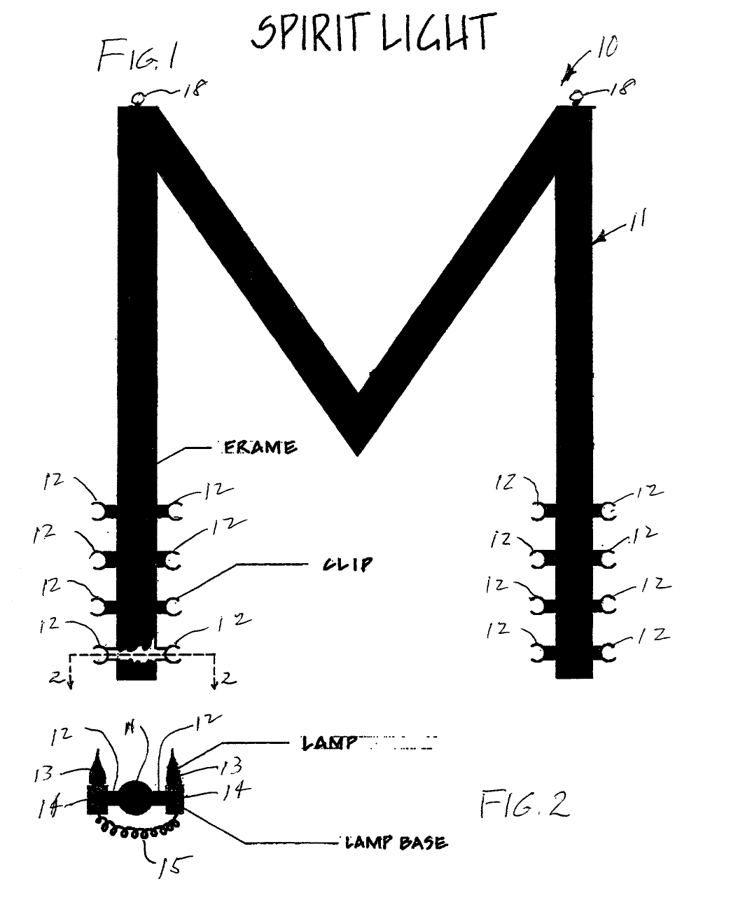

There is shown in FIG. 1 a lighted decoration 10 according to the present invention. The decoration 10 has a body 11 in the representative shape of a capital letter “M” which can represent, for example, the initial of a school name. The body 11 may also be in the shape of a school or sports logo, a holiday symbol, or the like. The body 11 is preferably constructed of plastic or similar material, and may be of a rounded, multi-faceted, or similar construction. The body 11 is outlined by a plurality of clips 12 extending outwardly from the sides of the body in the plane of the body. Although only eight clips 12 are shown near the bottom of each leg of the body 11, the clips extend along all edges of the body and are evenly spaced apart. The plurality of clips 12 outlines the body 11 in an appropriate design that produces the detail necessary to clearly identify the image or symbol intended. The body 11 is preferably “seethrough” clear plastic. The body 11 can also be of a suitable color, such as one of a school's or holiday's colors, while the lamps discussed below can be of a second school or holiday color. In addition, the lamps discussed below can be alternated in the two school or holiday colors. As also shown in FIG. 1, one or more eyelets 18 can be provided on the body 11 for suspending the lighted decoration 10 for display. Wire, string or the like (not shown) can be routed through the eyelets 18 for suspending the lighted decoration 10.

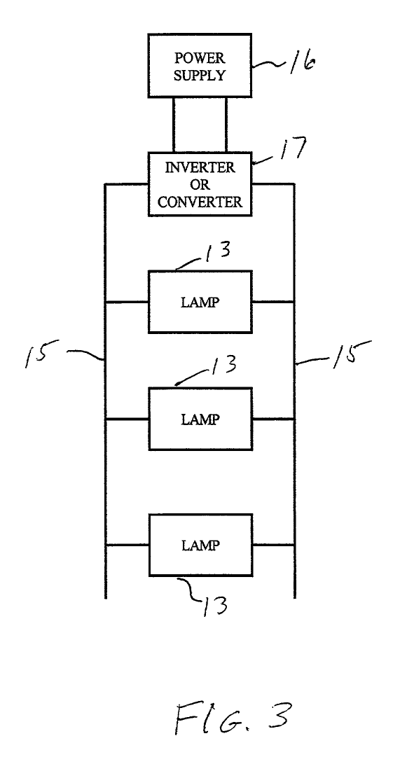

There is shown in FIG. 2 a cross section through one of the legs of the body 11 showing a lamp base 14 retained in each of the clips 12 and a lamp 13 installed in each of the bases. The lamps 13 are connected to wiring 15 to receive suitable electric power. The alignment of clip 12 in the plane of body 11 orients the top of the lamp 13 toward the viewer such that the clip 12 and the base 14 are substantially hidden, permitting closer spacing of the lamps 13 and enhancing the illumination effect of the lamps 13.

As shown in FIG. 3, the wiring 15 is connected to a suitable power supply 16 to light the lamps 13. The lamps 13 may be designed to operate from standard household a.c. power, or from a d.c. power source such as a battery. If the lamps 13 are designed to operate from standard a.c. power of the type available in houses, the wiring 15 is provided with a plug (not shown) of the type used with standard electrical outlets. If the power supply 16 and the lamps 13 are not compatible, it may become necessary to utilize a power changing device 17. If the lamps 13 are a.c. and the power supply 16 is d.c., such as a 12V car battery, then the device 17 is an inverter. If the lamps 13 are d.c. and the power supply 16 is a.c., then the device 17 is a converter.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A decorative apparatus for displaying various symbols comprising:
a body having a decorative shape to be viewed from a predetermined direction; and
a plurality of clips attached to said body, said clips being spaced apart about said body to form an outline of said decorative shape, said clips being further oriented towards said predetermined direction.

2. The apparatus according to claim 1 further including:
a plurality of lamps, each said lamp being releasably retained by an associated one of said clips whereby a top of said lamp is visible from said predetermined direction; and
wiring connected to said lamps for connection to a source of electrical power.

3. The apparatus according to claim 2 wherein said lamps are associated in a first group and including at least another plurality of lamps connected to said wiring and associated in a second group, said first and second groups being spaced apart, each of said first and second groups being attached to separate said clips and said bodies.

4. The apparatus according to claim 2 including means for suspending said body.

5. The apparatus according to claim 4 wherein said means for suspending said body is at least one eyelet attached to said body.

6. The apparatus according to claim 2 wherein said source for electrical power and the type of electrical power for which said lamps are designed are incompatible, further including:
means for supplying the correct type and magnitude of voltage connected between said electrical power and said lamps.

7. The apparatus according to claim 6 wherein said source for electrical power is alternating current voltage, said type of electrical power for which said lamps are designed is direct current voltage and said means for supplying the correct type and magnitude of voltage is a converter.

8. The apparatus according to claim 6 wherein said source for electrical power is direct current voltage, said type of electrical power for which said lamps are designed is alternating current voltage and said means for supplying the correct type and magnitude of voltage is an inverter.
